(19) United States
(12) Patent Application Publication
(10) Pub. No.: US 2005/0138089 A1
(43) Pub. Date: Jun. 23, 2005

(54) Data replication method

(75) Inventor: Michio Kasai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/979,113

(22) Filed: Nov. 3, 2004

(30) Foreign Application Priority Data
Dec. 19, 2003 (JP) 2003-423220

(51) Int. Cl. G06F 17/30

(52) U.S. Cl. 707/204

(57) ABSTRACT

Replication source data is accessed in units of physical blocks as is conventional, and the entire volume is transmitted to a replication destination. In the replication destination, the received data is stored as a file. In this case, the file is managed using a file system according to a replication destination operating system. Since a volume is managed as a file, there is no need for their respective types of replication source and destination operating systems to be the same, and there is also no need for their respective volume sizes to be the same.

### BACKGROUND OF THE METHOD

1. Field of the Invention

The present invention relates to a data replication method applicable among a plurality of systems equipped with a plurality of different platforms.

2. Description of the Related Art

With the today's development of a computer and the Internet, a lot of sales have been done using a computer and the Internet. In particular, each enterprise runs a computer and stores important information, such as client information and the like in a database as data every time it does business. However, when the database is destroyed by a disaster, such as an earthquake or the like, such stored data is lost. Therefore, if such stored data is related to the sales of the enterprise and is important, the enterprise must store the same data in another safe place in preparation for an unforeseen accident, such as a disaster. Therefore, recently an enterprise whose business is to store data, such as backup data and the like, for other enterprises, has appeared. A provider that provides such a service is called a storage service provider.

FIG. 1 shows a basic system configuration of such a storage service provider.

A storage service provider 10 has a data center equipped with anti-earthquake facilities, and even when an unforeseen accident, such as earthquake or the like, happens, it takes measures so that even if its building is destroyed, its computer and database may not be destroyed. Enterprises A, B and C, which are not prepared in such a manner, transmit data to be backed up to the storage service provider 10 through the Internet, in particular, a VPN (virtual private network) and have the data stored.

FIGS. 2A and 2B show such emergency storage service models.

FIG. 2A shows a business restoration model. In this model, a running center is connected to a restoration center, and the restoration center always mirrors the data of the running center using a remote mirror hardware function, and if the running center goes down, the running center is switched over to continue business.

FIG. 2B shows a data sheltering model. In this model, the backup data of the running center is stored in a remote place. The running center is connected to the backup center located in a remote place through a network, and backup data is transmitted to the backup center through the network and is stored there. As requested, after the completion of the data backup through a network, a tape storing the same data is transported by a truck and is stored in an anti-earthquake storage.

It can be anticipated that, of the above-mentioned service models, a data sheltering model may be adopted by an external service provider. In other words, since business restoration should be made in each enterprise, it is not practical for an external service provider to make the restoration only for a specific client. Therefore, a storage service provider, being an external service provider, must store a plurality of segments of data from a variety of clients.

FIGS. 3A-3C show how to conventionally back up data through a network.

FIG. 3A shows a method called “hardware application”. In this method, a running center is connected to a backup center through a public network, and also the respective data storage devices are connected through a dedicated network. This hardware application performs remote mirroring using a hardware function. The data storage device of each of the running and backup centers is provided with an exclusive replication firmware and replicates data in units of physical blocks. Therefore, the respective data storage devices of the running and backup centers store data in the same data structure. In order to handle data from the running center in the backup center, the backup center must introduce the same operating system as well as the same device as the running center. The capacity of the data storage device of the backup center, being a replication destination, must also be the same as that of the running center.

According to this method, although data can be backed up at high speed, facilities are costly, which is a problem. In this case, replication is one form of a backup method whose backup interval is shorter, for updating backup data by reading only a difference in data between before and after change when there is a change in original data, and by continuing to store the same data as the running center. In the following description, backup means backup whose backup interval of data is comparatively long, such as one in units of hours, days, weeks, months or the like, while replication means backup whose backup interval of data is comparatively short, such as one in units of minutes, seconds or the like. In replication, when backing up data, data is updated using only the difference in data.

FIG. 3B shows a network backup method using backup software. In this case, backup software is built in the computer of each of the running and backup centers, and backup data is transmitted through a public network. In this case, logical data is transferred. Generally, since backup software transmits full data to be backed up through a public network, the traffic of the public network increases and data cannot be backed up at high speed, which is a problem. However, since this method is inexpensive and logical data is transferred, the backup center does not depend on the system type of the running center, which is an advantage.

FIG. 3C shows a replication method using replication software.

In this method, the computer of each of the running and backup centers is provided with replication software, and remote mirroring is conducted by the software. In this case, data is replicated in physical blocks. According to this method, data can be backed up at high speed, a system can be configured at a low cost, which is an advantage. However, as in hardware replication, the respective operating systems of the running and backup centers must be the same, and the respective capacities of the data storage devices of replication source and destination must be the same.

In a backup service provided by a storage service provider, it is important to configure a system inexpensively, to back up data at high speed and for the system to be applied widely and easily.

However, in the above-mentioned conventional system, since replication by either hardware or software in which data can be backed up at high speed limits a system to be used, it cannot handle a variety of clients having a variety of systems. However, in a network backup having no system limitation, data cannot be backed up at high speed.

### SUMMARY OF THE INVENTION

It is an object of the present invention to provide a high-speed, inexpensive data replication method in which an applied system is not limited.

The data replication method of the present invention copies replication source data in a replication destination. The method comprises reading replication source data by physical block access, transferring the read data to a replication destination and storing the received data as the file of a filing system supported by a replication destination operating system.

In the present invention, the data read at a physical block level in a replication source is stored as a file in a replication destination under the control of a filing system. Thus, the type of the operating system in the replication destination is not limited when data is stored, and the data can be easily managed using the file management function of the replication destination file system.

According to the present invention, a high-speed, inexpensive data replication method in which an applied system is not limited can be applied. Therefore, even when a storage service provider provides a backup service, it can provide the service to a lot of and a variety of clients at a low cost.

### BRIEF DESCRIPTION OF THE DRAWINGS

FIG. 1 shows a basic system configuration of such a storage service provider;

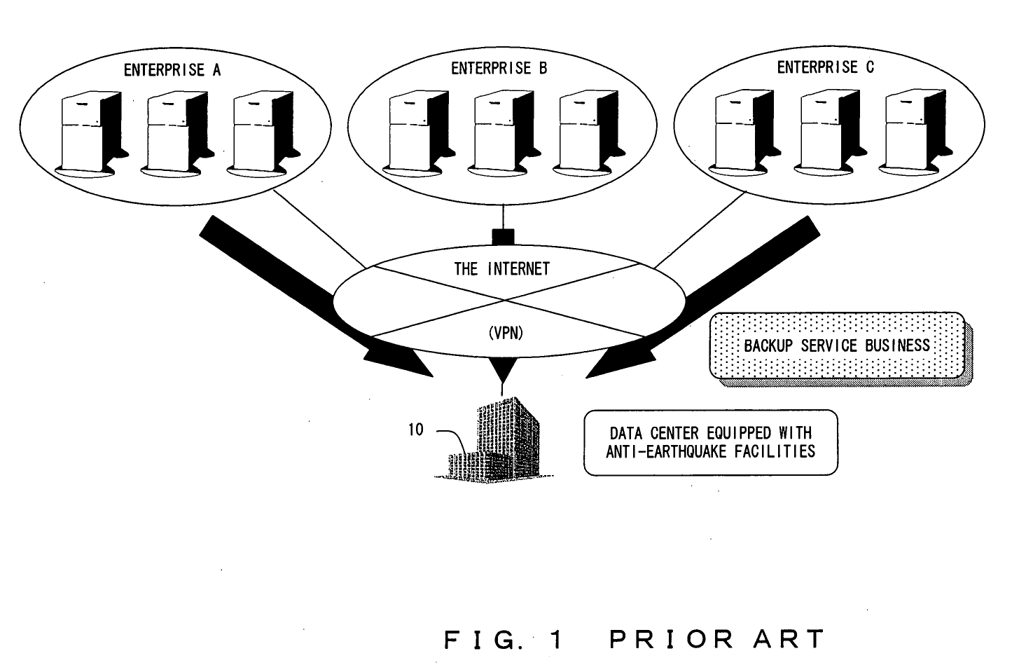

FIGS. 2A and 2B show such emergency storage service models;

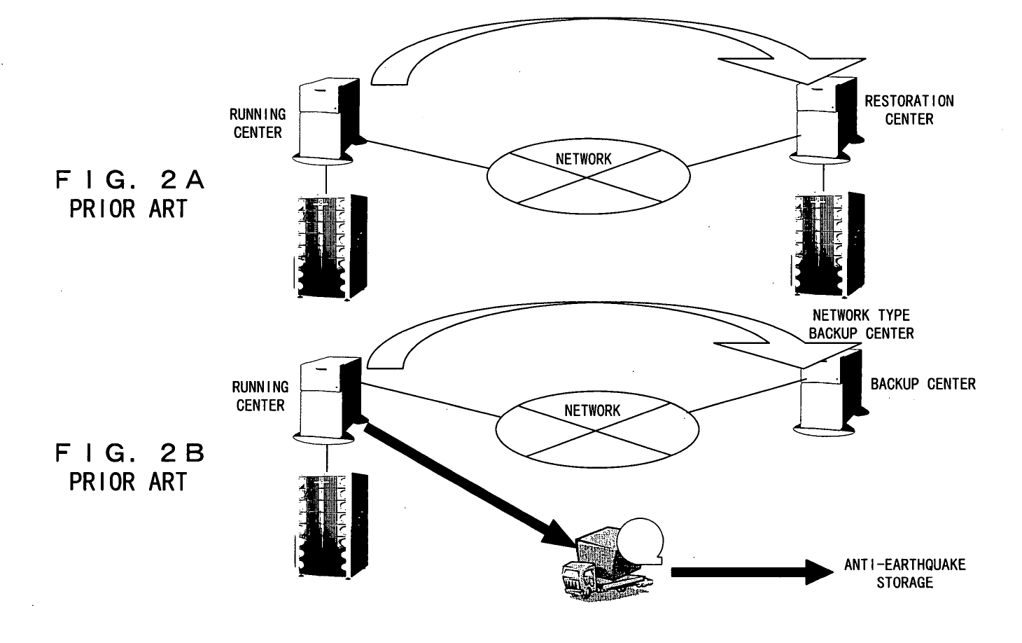

FIGS. 3A-3C show how to conventionally back up data through a network;

FIGS. 4A and 4B show the preferred embodiment of the present invention;

FIG. 5 shows the operation of the preferred embodiment of the present invention;

FIGS. 6A and 6B show the process flows at the time of replication; and

FIG. 7 shows recovery from a replication destination.

### DESCRIPTION OF THE PREFERRED EMBODIMENTS

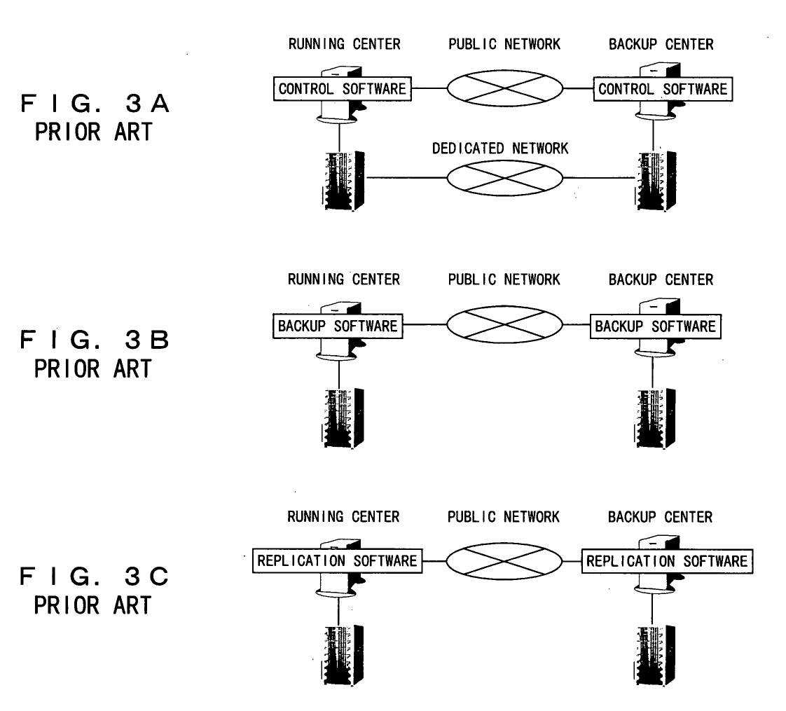

The preferred embodiment of the present invention is described based on the replication by software shown in FIG. 3C. In the conventional replication by software, a replication function is built in without affecting the existing system. Therefore, data from a computer is intercepted in a layer (physical block layer) ordered lower than the layer of a filing system, and is transmitted to a replication destination. In the replication destination, the data is stored in a physical block layer. Therefore, although high-speed replication can be realized, the respective capacities of replication source and destination storage devices must be the same, and their respective types of the replication source and destination operating systems must also be the same. Thus, the preferred embodiment of the present invention is configured as follows.

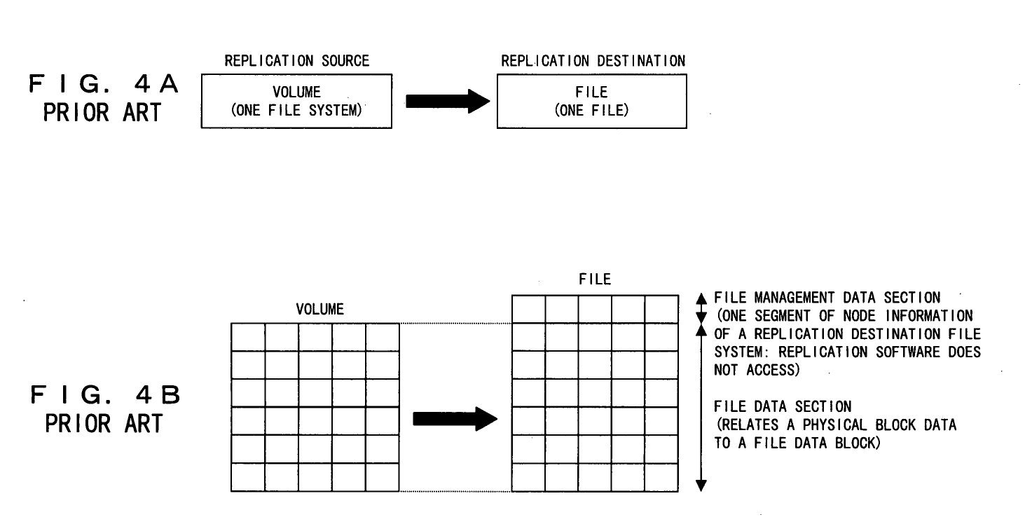

FIGS. 4A and 4B show the preferred embodiment of the present invention.

In the preferred embodiment of the present invention, as shown in FIG. 4A, one volume of a replication source file system is stored as one file in a replication destination. The replication destination file becomes a large-capacity file equivalent to the replication source volume size. FIG. 4B shows the correspondence between a replication source volume and a replication destination file. As shown on the left side of FIG. 4B, in the replication source, the volume of the entire storage area of the data storage device is copied and converted into a replication destination file. This file is divided into a file management data section and a file data section, and the replication source physical block data is stored in the file data section. The file management section is used to manage the files of replication destination operating system without the access of a replication program.

Thus, data can be recognized by an arbitrary replication destination file system independent of the replication source system. In the replication destination, since replication data can be recognized by the file system, there is no need for the volume size of the replication destination data storage device to be the same as that of the replication source data storage device. Specifically, in the conventional copying in units of physical blocks, since in the replication destination, replication source file system information is also copied, in the replication destination, the file system information must be read by the same type of operation system as that of the replication source. In order for the copied file system information to be effective, the respective replication source and destination data volume sizes must be the same.

However, in the preferred embodiment of the present invention, since in the replication destination, the file system manages the replication data as a file, it is passable only if the replication destination data volume is larger than the replication data, there is no need for the same type of operating system to be used in both the replication source and destination since the replication destination file system operates independently of the replication source file system, which is an advantage.

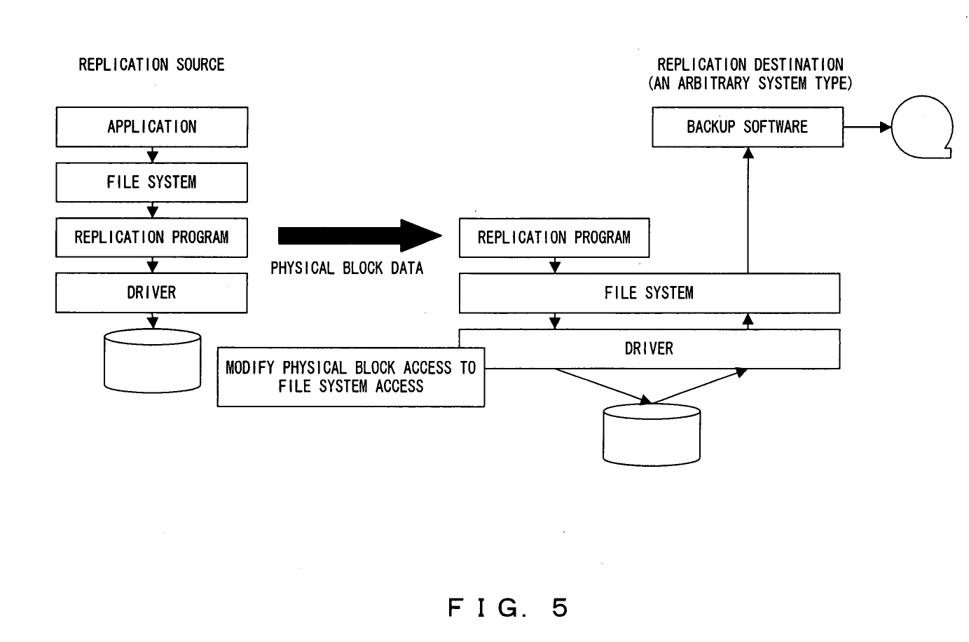

FIG. 5 shows the operation of the preferred embodiment of the present invention.

In the replication source, an instruction to write data and the like is transmitted from application to a file system. In the case of writing, data to be written is also transmitted from the application to the file system. From the file system, the data is transmitted to the driver of the storage device. In this case, the replication program intercepts the data transmitted from the file system to the driver, and transmits it to the replication destination as physical block data. In the replication destination, the replication program transfers the received data to the file system and writes it into the storage device through the driver. In other words, the replication source physical block access is modified to a replication destination file system access. Thus, the replication data stored in the replication destination can be read later by backup software and can be stored in a tape or the like.

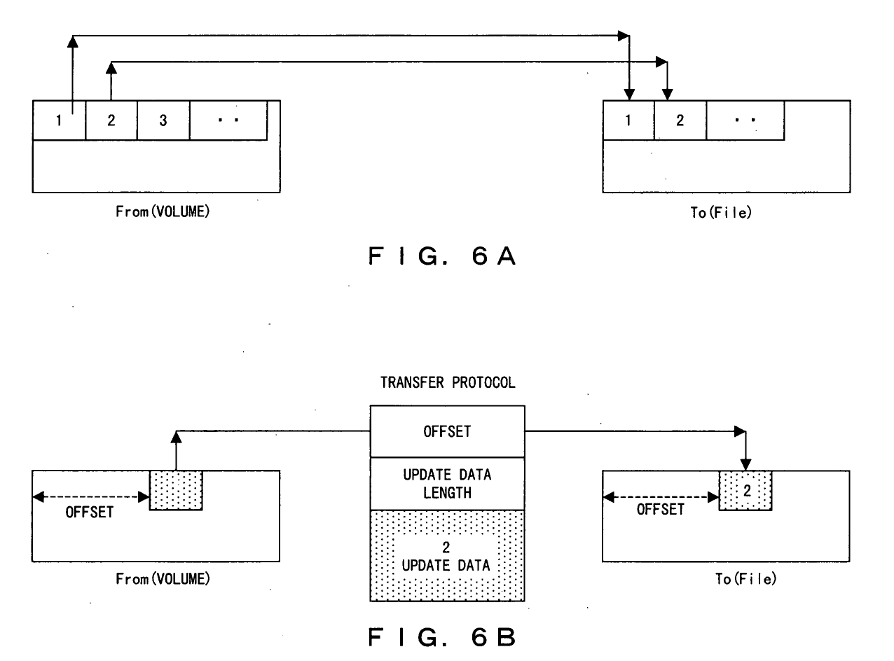

FIGS. 6A and 6B show the replication flows.

FIG. 6A shows its initializing operation. Firstly, the replication source volume is opened. Then, the replication destination file is opened. Then, the replication source physical blocks are sequentially read, and data is transmitted to the replication destination server. In the replication destination, the received data is written into a file. Reading the physical data, transferring it and writing it into the file are repeated for all segments of data until they are completely processed. Thus, replication source backup data is generated in the replication destination.

FIG. 6B shows its mirroring operation. The location in a replication destination of update block (offset from the beginning of a volume), update data length and update data are transmitted to the replication destination. In the replication destination, the offset is extracted from the received data, and is located at its position from the beginning of a file. Then, the update data for the update data length is written. The above-mentioned process is performed every time new update data in the replication source occurs, to implement the mirror function.

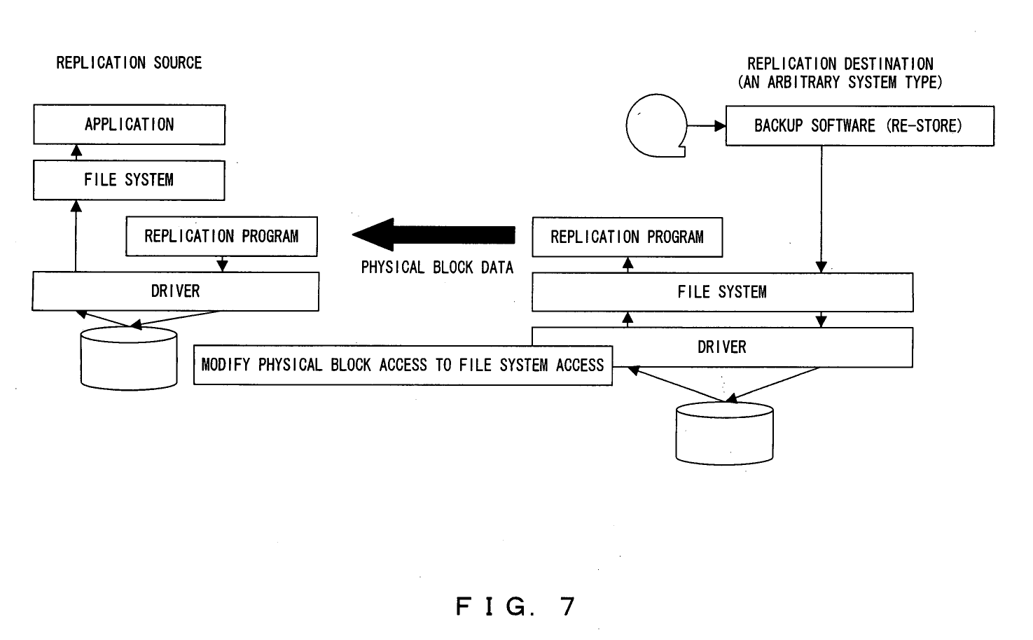

FIG. 7 shows its recovery from the replication destination.

In the replication destination, the data stored in a tape or the like is stored in the storage device using backup software. Then, its replication program reads the backup data of the storage device, and transmits it to the replication source replication program as physical block data. In the replication source, the received data is written into the storage device. Thus, recovery can be easily made.

According to the preferred embodiment of the present invention, the following effects are obtained.

(1) Multi-platform volume backup is possible in the replication destination of one system, and when backing up data, in a replication destination there is no need to prepare the same system as in a replication source. Therefore, a replication system can be configured at a low cost. Accordingly, since a backup operator can configure the most favorite system, the operator can easily operate it.

(2) Since its backup does not depend on a replication source volume size, it is acceptable only if a replication destination volume capacity is equivalent to the replication source volume size. Therefore, since there is no need to set up a slice partition in advance, the system can be easily configured and there is no need to modify the environment definition. Since a file system is used, monitoring by space management software can be easily conducted. Since a file system is used, the capacity extension of the replication destination file system can also be easily used without any modification and its space extension is easily made, there is no need to be conscious of its logical block size.

(3) Since high-speed backup by replication removal, differential data transfer by replication stoppage/restart (high-speed generation backup), network load control (keeping a network load constant) and operational environment building by multi-vender storage response can be realized at a low cost without losing the features of the conventional replication software and can be added on to the replication destination system, they can be easily introduced.

1. A data replication method for copying replication source data in a replication destination, comprising:
reading replication source data by physical block access;
transferring the read data to a replication destination; and
storing the received data as a file of a file system supported by a replication destination operating system.

2. The data replication method according to claim 1, wherein
said reading, transferring and storing are repeated every specific times and the replication destination data is always kept the same as the replication source data.

3. The data replication method according to claim 2, wherein
if the replication destination data is always kept the same as the replication source data, only a difference in replication source data between before and after update is transferred to replication destination.

4. The data replication method according to claim 1, wherein
the data copied in the replication destination is stored and kept in a storage medium, such as a tape or the like.

5. A program for enabling a computer to copy replication source data in a replication destination, comprising:
reading replication source data by physical block access;
transferring the read data to a replication destination; and
storing the received data as a file of a file system supported by a replication destination operating system.

6. The program according to claim 5, wherein
said reading, transferring and storing are repeated every specific times, and the replication destination data is always kept the same as the replication source data.

7. The program according to claim 6, wherein
if the replication destination data is always kept the same as the replication source data, only a difference in replication source data between before and after update is transferred to a replication destination.

8. The program according to claim 5, wherein
the data copied in the replication destination is stored and kept in a storage medium, such as a tape or the like.

9. A data replication device for copying replication source data in a replication destination, comprising:
a reading unit reading replication source data by physical block access;
a transfer unit transferring the read data to a replication destination; and
a storage unit storing the received data as a file of a file system supported by a replication destination operating system.

10. The data replication device according to claim 9, wherein
said reading, transferring and storing are repeated every specific times and the replication destination data is always kept the same as the replication source data.

11. The data replication device according to claim 10, wherein
if the replication destination data is always kept the same as the replication source data, only a difference in replication source data between before and after update is transferred to a replication destination.

12. The data replication device according to claim 9, wherein
the data copied in the replication destination is stored and kept in a storage medium, such as a tape or the like.
